(19) United States
(12) Patent Application Publication
(10) Pub. No.: US 2017/0061040 A1
(43) Pub. Date: Mar. 2, 2017

(54) Automated Three-Dimensional Location Verification of Construction Items

(71) Applicants: Alex Michael Solnick, Buchanan, NY (US); Steven Michael Colletta, Ridgewood, NJ (US); Robert E. Daros, JR., Yonkers, NY (US); Steven Phillip Gologorsky, Montville, NJ (US); Frank J. Sciame, JR., Lattingtown, NY (US)

(72) Inventors: Alex Michael Solnick, Buchanan, NY (US); Steven Michael Colletta, Ridgewood, NJ (US); Robert E. Daros, JR., Yonkers, NY (US); Steven Phillip Gologorsky, Montville, NJ (US); Frank J. Sciame, JR., Lattingtown, NY (US)

(21) Appl. No.: 15/255,682

(22) Filed: Sep. 2, 2016

Related U.S. Application Data
(60) Provisional application No. 62/213,395, filed on Sep. 2, 2015.

(51) Int. Cl. G06F 17/50

(52) U.S. Cl. CPC G06F 17/5004

(57) ABSTRACT

Embodiments are directed to real-time, automated location verification to ensure that construction items are positioned in a correct location and orientation in three dimensions (x, y, z) as identified by model data for a construction site prior to finalization of the construction items. Systems and methods are provided for precisely locating and determining a position/orientation of a placed item at a construction site, verifying whether the position/orientation is correct, and providing an indication (e.g., a confirmation or an alarm) in real-time as to whether the item is placed correctly, placed incorrectly, or missing. The systems and methods provided herein thus result in avoiding costly misplacements and the required re-workings before they happen (i.e., by allowing correction of the location/placement prior to final and permanent installation).

### CROSS-REFERENCE TO RELATED APPLICATIONS

This application claims priority to U.S. Provisional Patent Application No. 62/213,395, filed on Sep. 2, 2015 and entitled “Automated Three-Dimensional Location Verification of Construction Items,” the contents of which are incorporated herein by reference in its entirety.

### BACKGROUND

In the construction industry, there is a well-developed and information-rich process of design and coordination to determine exactly where construction items should be located at a construction site. These locations are dimensioned to very tight tolerances on design drawings.

However, there is no corresponding automated way to verify that these coordinated construction items are in fact accurately placed on site, with respect to position and orientation. In fact, a disconnect often exists between the extremely detailed, complex, and heavily coordinated design information and the location/verification process at the construction site. This leads to costly errors as a result of inaccurate placement (i.e., inaccurate location of construction items).

Inaccurate location of construction items is common at construction sites. In some instances, the exact placement of certain construction items may be difficult to achieve based on challenges in the design of the project. In other cases, time constraints may not allow the proper locating procedures to occur. In still other cases, human error is the cause. This can be through an incorrect initial location or an inadvertent movement of the item after the correct placement of the item has occurred, but prior to finalization (i.e., setting in concrete, final securing, etc.).

Traditionally, the location and verification of construction items is done manually on a piece-by-piece basis using conventional surveying tools such as transit levels, surveying rods, measuring tapes, planimeters, lasers, prisms, theodolites, etc. However, this is a time-consuming solution that can only be performed by specialized personnel. First, they must review the entire design of the project to familiarize themselves with the dimensional locations of each item, as well as the fixed locations at the site location that each item will be referenced to. Then they must travel to the site location, which may be some distance from their regular location. Once on the site, they must set up a system of complex measuring devices in order to verify the proper locations of construction items in a small geographic area. Once items in this area are located, the measuring devices are taken apart and re-assembled at a new location to locate additional items. This “set up-locate-disassemble” process occurs multiple times in a series of temporary locations until all of the devices are located. The equipment must be moved from location to location because it is not economically feasible for the surveying professional to have multiple surveying systems. Additionally, the surveying devices, if left in place, interfere with the ongoing construction activities.

Moreover, a subsequent location and verification of the construction item performed to ensure inadvertent movements of the items have not occurred prior to finalization is done the same way as the initial locating process. Although it is desirable to constantly confirm that items remain located properly and have not been moved, verification of location is only done sporadically after the initial placement due to the extensive cost and time required to manually recheck each item.

Thus, there is a need for an improved method of location and verification of construction items during the period of time between initial installation and permanent placement (i.e., finalization) at a construction site.

### SUMMARY

Embodiments disclosed herein are directed to systems and methods for locating and verifying location of a construction item.

According to an embodiment, a system for real-time, automated location verification to ensure that construction items are installed in a correct position and orientation in three dimensions as identified by model data for a construction site is provided. The system comprises: one or more construction items, each with a corresponding tag, on the construction site; a database for storing the model data for the construction site; one or more transceivers located on the construction site; and a server in communication with the database and the one or more transceivers. The server is configured to: receive, from one or more of the one or more transceivers, data indicative of one or more of a location and an orientation of one of the one or more constructions items at the construction site; determine if the model data and the received data relating to the one of the one or more construction items at the construction site are equivalent; and store data indicative of the determination.

In an embodiment, the server is further configured to provide, to one or more user devices in communication with the server, a communication reflective of the determination prior to finalization of the one of the one or more construction items. In an embodiment, the communication reflective of the determination comprises one or more of (i) an alarm message sent to one or more of the one or more user devices; (ii) a conformance report indicating the one of the one or more construction items, the model data, and the received data; and (iii) a graphical format describing one or more of: a correctness of the location of the one of the one or more construction items; a correctness of the orientation of the one of the one or more construction items; and an absence of the one of the one or more construction items. In an embodiment, the server provides the communication reflective of the determination at one or more of (i) upon the determination by the server and (ii) a predetermined time interval.

According to an embodiment, the corresponding tags of the one or more construction items communicate to one or more of the server and each other over one or more of a network and a mesh network. In an embodiment, the corresponding tags comprise one of a barcode tag, a radio frequency identification (RFID) tag, a global positioning system (GPS) tag, and an ultra-wide band tag. The corresponding tags of the one or more construction items, according to an embodiment, communicate with the one or more transceivers configured to receive timing information from the corresponding tags of the one or more construction items and transmit the timing information to the server over a wireless access point. In an embodiment, the server is further configured to convert the timing information to distance information to locate the one of the one or more construction items.

In an embodiment, the system further comprises one or more hand-held devices configured to (i) read data from the tag of the one of the one or more construction items, and (ii) transmit the read data to the server.

In an embodiment, the model data and the received data for the one of the one or more construction items comprises one or more sets of (x, y, z) coordinates.

In an embodiment, the server is further configured to extract the model data for the construction site from a three-dimensional coordinated model of the construction site.

In an embodiment, the server is further configured to, in the determination of if the model data and the received data relating to the one of the one or more construction items at the construction site are equivalent, apply one or more tolerances to the one of the one or more construction items, the one or more tolerances based on at least one of federal, state, local, and industry standard codes.

In another embodiment, a method for real-time, automated location verification to ensure that construction items are installed in a correct position and orientation in three dimensions as identified by model data for a construction site is provided. The method comprises: storing, at a database associated with a server, the model data for the construction site; receiving, at the server, from one or more transceivers located on the construction site, data indicative of one or more of a location and an orientation of one of one or more constructions items at the construction site; determining, by the server, if the model data and the received data relating to the one of the one or more construction items at the construction site are equivalent; and storing, by the server, data indicative of the determination.

In yet another embodiment, a system for real-time, automated location verification to ensure that construction items are installed in a correct position and orientation in three dimensions as identified by model data for a construction site is provided. The system comprises: one or more construction items, each with a corresponding tag; a database for storing the model data for the construction site; one or more movable transceivers positioned sequentially at one or more surveyed locations on the construction site, the one or more movable transceivers configured to receive timing information from the corresponding tags of the one or more construction items; and a server in communication with the database and the one or more movable transceivers. The server is configured to: receive, over a wireless access point from one or more of the one or more movable transceivers, the timing information for one of the one or more construction items; convert the timing information to distance information to locate the one of the one or more construction items; determine if the model data and the converted distance information relating to the one of the one or more construction items at the construction site are equivalent; and store data indicative of the determination.

An additional embodiment provides a system for real-time, automated location verification to ensure that construction items are installed in a correct position and orientation in three dimensions as identified by model data for a construction site, the system comprising: one or more construction items; a database for storing the model data for the construction site; one or more fixed transceivers positioned on the construction site; one or more movable transceivers positioned sequentially at one or more of the one or more construction items on the construction site, the one or more movable transceivers configured to receive timing information from the fixed transceivers; and a server in communication with the database and the one or more movable transceivers. The server is configured to: receive, over a wireless access point from one or more of the one or more movable transceivers, the timing information for one of the one or more construction items; convert the timing information to distance information to locate the one of the one or more construction items; determine if the model data and the converted distance information relating to the one of the one or more construction items at the construction site are equivalent; and store data indicative of the determination.

In an embodiment, the one or more movable transceivers read data from coding on a model drawing representing the one of the one or more construction items, and transmit the read data with the timing information to the server to coordinate a desired location with the model data at the server.

According to an embodiment, the one or more movable transceivers read data from a tag of the one of the one or more construction items, and transmit the read data with the timing information to the server to coordinate a desired location with the model data at the server.

In an embodiment, the one or more movable transceivers obtain input from a user as to an ad hoc location of the one of the one or more construction items, and transmit the input with the timing information to the server to coordinate a desired location with the model data at the server.

Additional features and advantages are apparent from the following detailed description that proceeds with reference to the accompanying drawings.

### BRIEF DESCRIPTION OF THE DRAWINGS

The foregoing and other aspects of the invention are best understood from the following detailed description when read in connection with the accompanying drawings. The drawings depict embodiments solely for the purpose of illustration; it should be understood, however, that the disclosure is not limited to the specific instrumentalities disclosed. Included in the drawings are the following Figures:

FIG. 1 is a block diagram illustrating a system for verifying location of a construction item at a construction site, according to an embodiment;

FIGS. 2A-2G are a series of diagrams illustrating execution of the system of FIG. 1, for verifying location of one or more construction items, according to an embodiment;

FIG. 3 is a block diagram illustrating a system for verifying location of a construction item at a construction site, according to an additional embodiment;

FIGS. 4A-4C are example site diagrams illustrating model data and location information for construction items at a construction site, according to an embodiment;

FIG. 5 is an example resultant graphic generated upon implementation of a location verification method provided herein, according to an embodiment;

FIG. 6 is an example conformance report generated upon implementation of a location verification method provided herein, according to an embodiment;

FIG. 7 is a flowchart illustrating an exemplary method for verifying location of a construction item at a construction site, according to an embodiment;

FIGS. 8A-8F are a series of diagrams illustrating features of an exemplary location technology that may be utilized with aspects for verifying location of a construction item at a construction site, according to an embodiment; and

FIG. 9 is a block diagram illustrating a system for verifying location of a construction item at a construction site, according to yet another embodiment.

### DETAILED DESCRIPTION

Embodiments are directed to a real-time, automated location verification system and method to ensure that construction items (hereinafter items, components, or elements) are positioned in a correct location and orientation in three dimensions (x, y, z) as identified by model data for a construction site prior to finalization of the construction items. Each construction item may have more than one set of coordinates which are required to be correct in order to confirm proper placement.

According to embodiments provided herein, construction items may include, but are not limited to, the following: curtain wall embeds; steel anchor bolts; Mechanical, Electrical, Plumbing (MEP) components; slab penetrations; embedded steel columns; slab geometry; slab camber; electrical outlets; thermostats; plumbing stub ups; hose bibs; vent stacks; and drains. In an embodiment, any item that is being placed and/or secured as part of a construction project may be considered a construction item. In an embodiment, construction items may fall into one of many categories including, but not limited to: structural, facade-related, MEP, and interior finishes.

As used herein, finalization of the construction items refers to the permanent placement of the construction items. Finalization may include one or more of the following: pouring concrete, securing bolts, painting, closing walls, installation of services to support the item (wiring, piping, support structures, access openings, inspection areas, etc.), providing subsequent construction work which is based upon the item, and any other actions that are costly to undo.

In the construction of a building or other structure (e.g., a bridge, dam, roadway, modular structure, temporary structure, etc.), it is extremely critical that items are accurately placed or located, with respect to position and orientation. Accurate location is dictated by a design model that precisely indicates specifications, including position and/or orientation, for construction items for a particular construction project. If one item is incorrectly located, a chain effect may occur, resulting in incorrect location and placement of numerous other items. Alternatively, an incorrect placement that goes unnoticed may not properly connect to items which will not be installed until a future date.

Once the inaccurate placement is identified, the courses of remediation to correct the error may be very costly and/or time-consuming, delaying or halting construction. For example, plans and models may need to be reworked to account for the inaccurate locations and placements; engineering design calculations (such as load calculations, shear wall opening dimensions, etc.) must be re-performed; and/or the items inaccurately placed may need to be removed and correctly replaced (often requiring the removal of properly installed surrounding items). The difficulties of such work are of a large magnitude for certain construction items, such as, for example, curtain wall embeds, steel anchor bolts, MEP components, slab penetrations, embedded steel columns, unique slab geometries, and slab cambers. These could involve entire areas of the building to require partial demolition and subsequent rebuilding.

According to embodiments provided herein, systems and methods are provided for precisely locating and determining a position/orientation of a placed item at a construction site, verifying whether the position/orientation is correct, and providing an indication (e.g., a confirmation or an alarm) in real-time of whether the item is placed correctly, placed incorrectly, or missing, prior to finalization of the item. The systems and methods provided herein thus result in avoiding costly misplacements and the required re-workings before they happen (i.e., by allowing correction of the location/placement prior to final and permanent installation).

In embodiments provided herein for verifying location of a construction item at a construction site, various location and/or sensing technologies may be utilized. Such technologies include but are not limited to radio frequency (RF) technology, global positioning system (GPS) technology, global navigation satellite system (GNSS) technology, other satellite-based infrastructure technologies, ultra wide-band technology, location sensing techniques, trilateration techniques, angulation techniques, ultrasound solutions, infrared-based solutions, proximity techniques, laser techniques, magnetic techniques, optical techniques, camera-based solutions, and various combinations of different available technologies that are capable of identifying a location of an item.

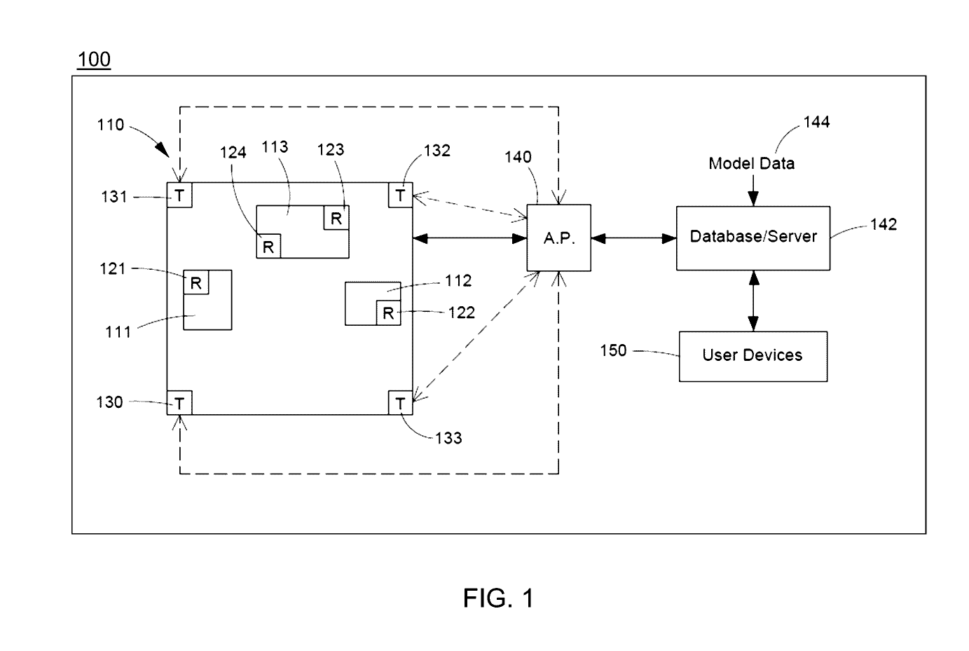

With reference to FIG. 1, a system 100 is provided for verifying location of a construction item at a construction site 110, according to one embodiment that utilizes RF technology. In this embodiment, the construction site 110 includes various construction items 111, 112, and 113. Each item 111, 112, and 113 is provided with one or more RFID tags. Note that some items may have more than one RFID tag, such as item 113. In the exemplary system shown in FIG. 1, item 111 has RFID tag 121, item 112 has RFID tag 122, and item 113 has RFID tags 123 and 124. The number of tags will be determined such that the proper positioning of the item can be verified. The RFID tags 121, 122, 123, and 124 may be adhered to, embedded within, or otherwise attached to a portion of the respective construction item 111, 112, and 113. In one embodiment, the RFID tags 121, 122, 123, and 124 are active RFID tags.

Of course, additional or fewer items may be included and tagged for location verification. Moreover, it is not necessary for the location of each and every construction item to be verified. Such determination as to which items to be included in the location verification may be done on a case-by-case basis, as determined by project managers or the like, for example.

The system 100 also includes one or more transceivers (as shown, transceivers 130, 131, 132, and 133). Fewer or additional transceivers may be provided.

Also included in the system 100 is a wireless access point (AP) 140 and a computer-based data processing system (“database/server”) 142. The wireless AP 140 serves as a link between the transceivers 130, 131, 132, and 133 and the database/server 142. The wireless AP can be either a single unit or a system of units and/or other technologies known to those skilled in the art (i.e., Leaky coax, directional transceivers, etc.) capable of linking the database/server 142 to the transceivers 130, 131, 132, and 133. The database/server 142 includes one or more processors necessary for executing instructions for performing the location verification method provided herein. The database/server 142 can be any type of processing and storage device known to those of ordinary skill in the art.

The database/server 142 includes, in a storage module, model information for one or more construction sites. According to an embodiment, information (i.e., data) from the model (model data 144) for a construction site is downloaded or otherwise inputted to the database/server 142, to be used for the location verification method. The model of a construction site for a project may be, in an embodiment, a three-dimensional coordinated model that includes an architectural design model that is overlaid with drawings from various disciplines and contractors (e.g., electrical and plumbing). The model identifies a location (x, y, z) for the construction items to be used in the construction project. The model data 144 that is downloaded to the database/server 142 is, according to an embodiment, the modeled (x, y, z) location information for each of the construction items of interest (e.g., all of the construction items for a site or a subset thereof).

The transceivers 130, 131, 132, and 133 are configured to receive timing information from an RFID tag 121, 122, 123 or 124 and transmit the timing information to the wireless AP 140. The timing information 140 is provided to the database/server 142, which converts the timing information to distance and uses trilateration technology to locate the particular construction item 111, 112, or 113 corresponding to the RFID tag 121, 122, 123, or 124 (e.g., determine the (x, y, z) location of the particular construction item).

The database/server 142 then compares the identified location to the extracted model data 144 for a particular construction item 111, 112, or 113 to determine if the location is correct or incorrect. A confirmation or alarm is generated, by the database/server 142, and sent to one or more user devices 150. The confirmation or alarm may be in various forms, such as an email message, text message, a graphical expression on a display device, a report (described in greater detail below), a pop-up message, or the like. Moreover, the confirmation or alarm may be sent at various intervals or predetermined times, or displayed in real time, and may also depend upon the type of location determination made by the database/server 142. For example, if the location of a particular construction item 111, 112, or 113 is correct, a confirmation message may be sent at a regularly scheduled time; if, however, an alarm is generated by the database/server 142, one or more alarm messages may be sent as soon as the alarm situation (i.e., the incorrect location) is detected and prior to finalization of the item 111, 112, or 113. One or more users may set personal settings related to message type and frequency.

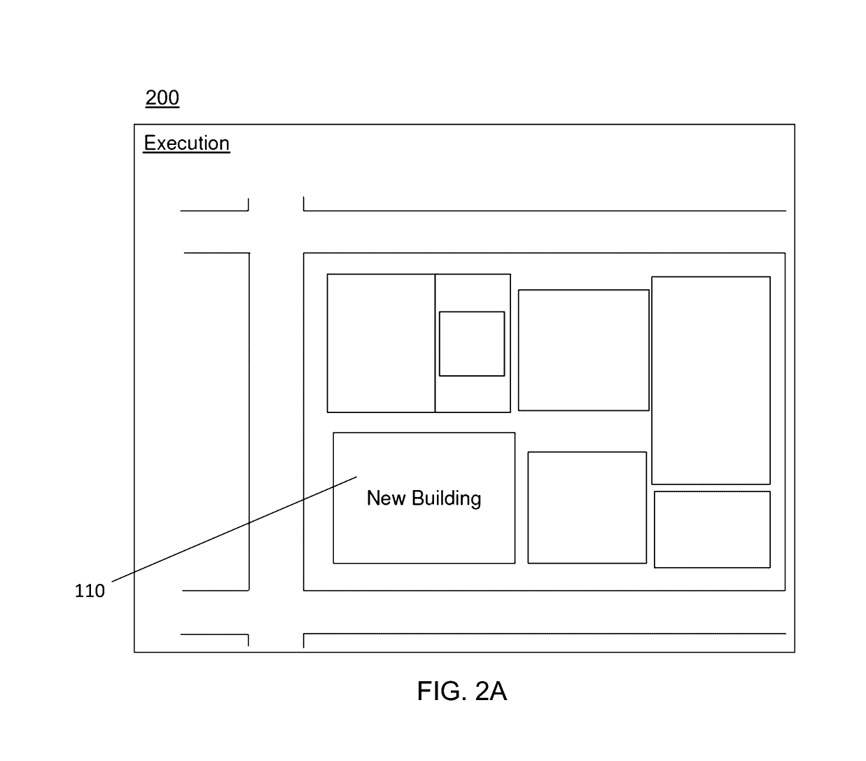

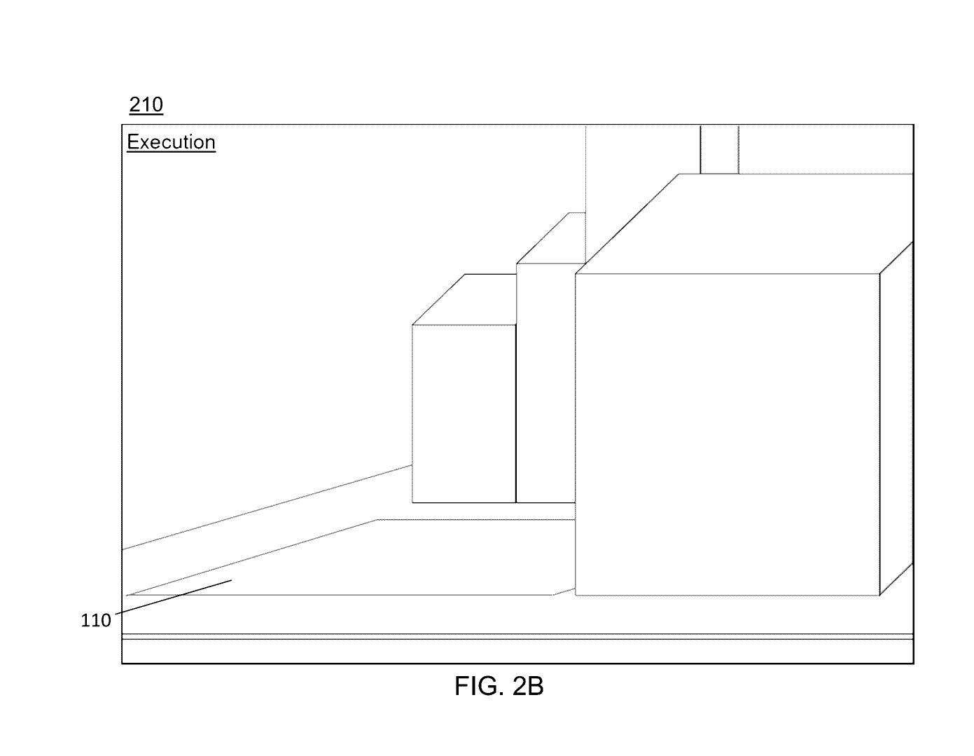

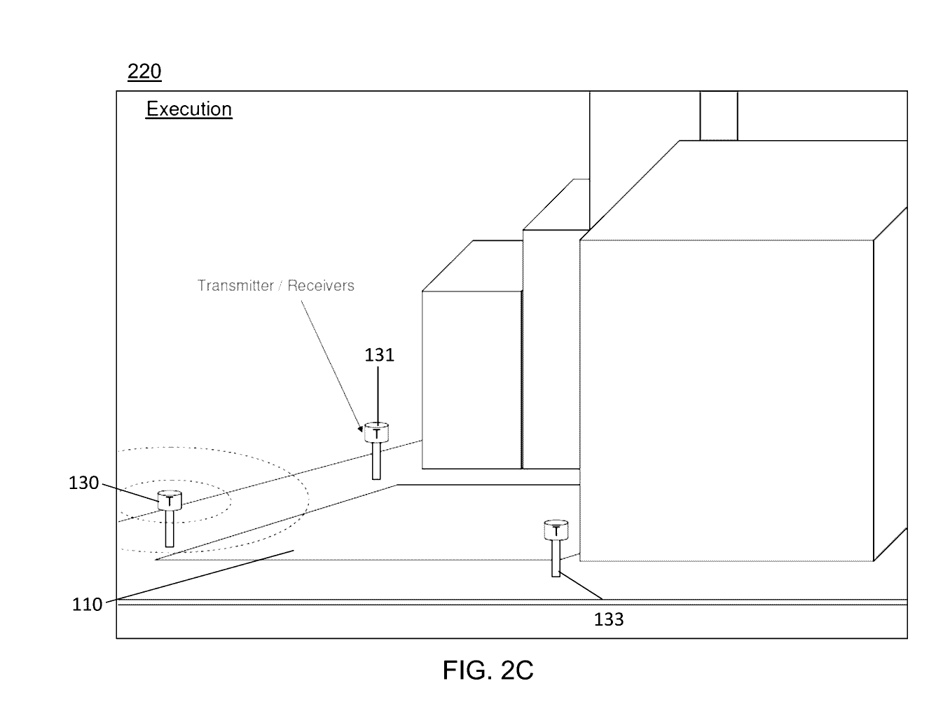

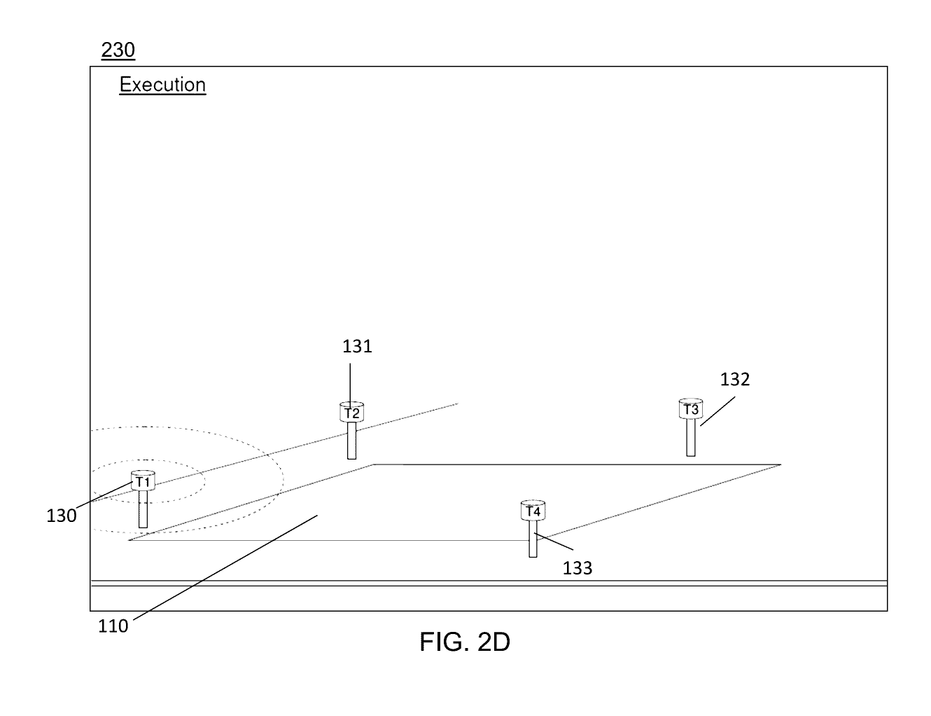

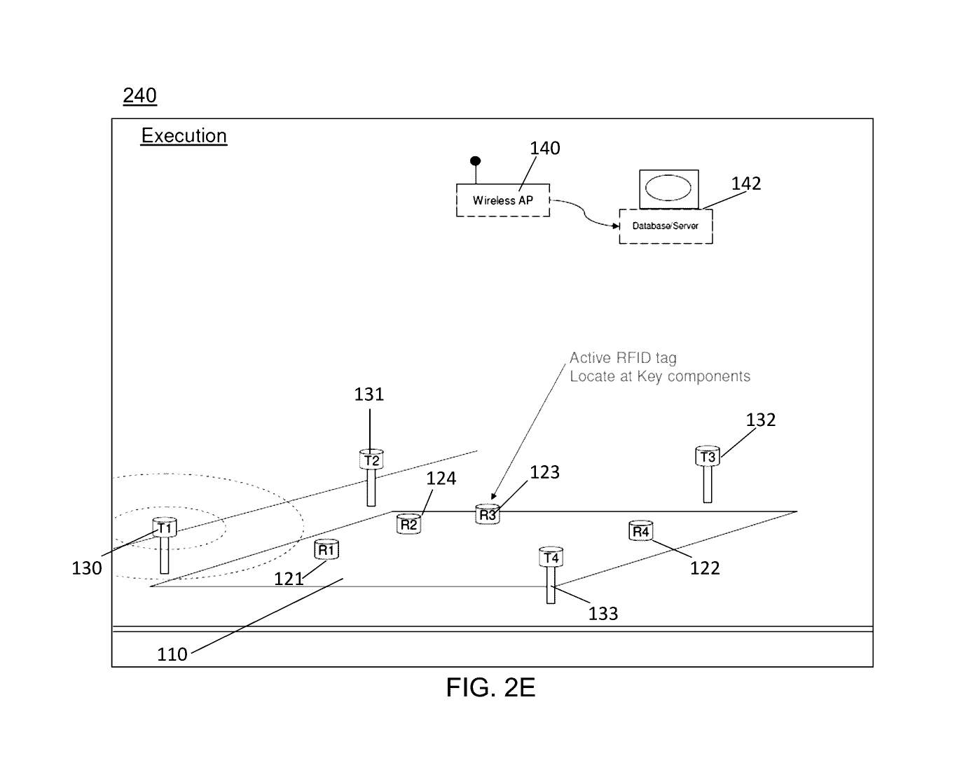

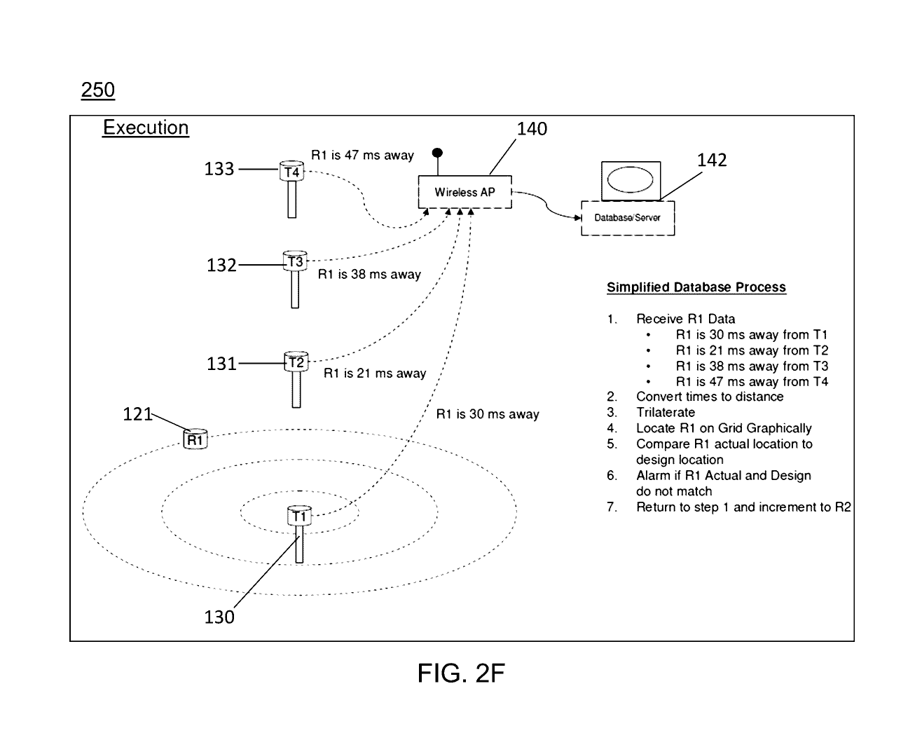

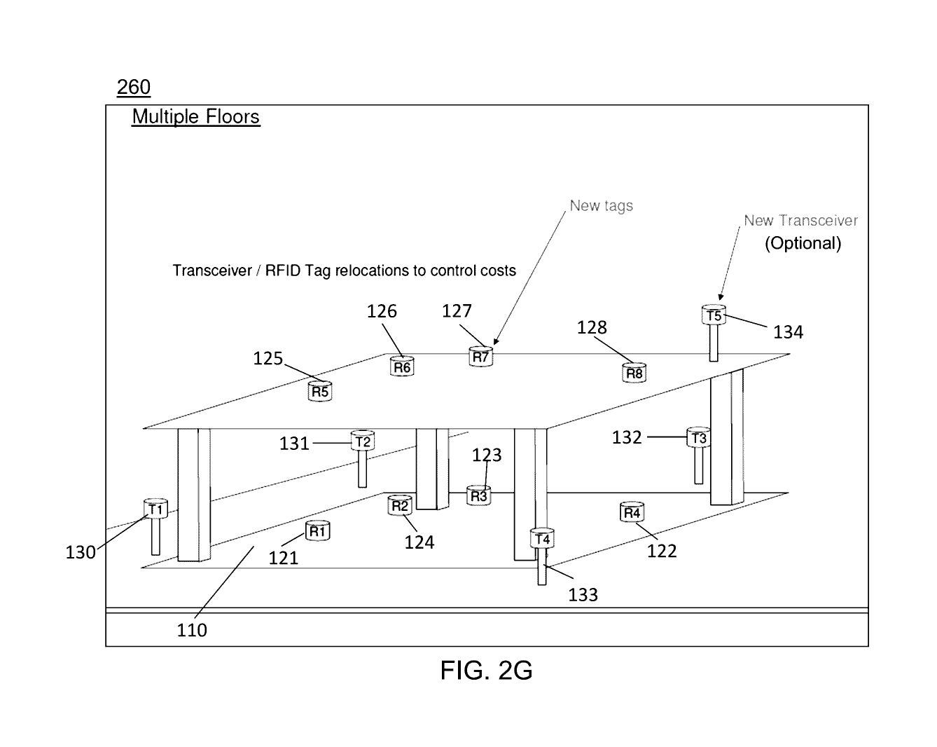

FIGS. 2A-2G are a series of diagrams 200-260 illustrating exemplary execution and implementation of the system 100 of FIG. 1, for verifying location of one or more construction items at a construction site 110 using a plurality of transceivers 130, 131, 132, 133, and 134 to locate a particular construction item. As shown, a plurality of transceivers are used to communicate timing distance of RFID tags 121, 122, 123, 124, 125, 126, 127, and 128 to a database/server 142, via a wireless access point 140.

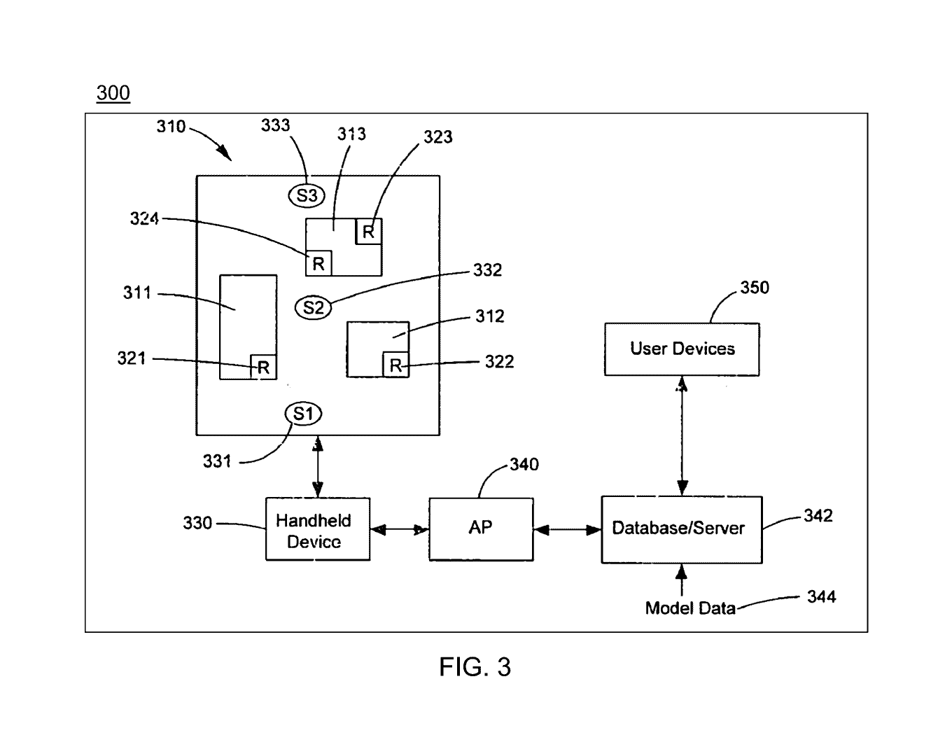

With reference to FIG. 3, a system 300 is provided for verifying location of a construction item at a construction site 310, according to an additional embodiment.

In this embodiment, the construction site 310 includes various construction items 311, 312, and 313. Each item 311, 312, and 313 is provided with a one or more sensors or tags. Item 311 has sensor or tag 321; item 312 has sensor or tag 322; and item 313 has sensors or tags 323 and 324. The sensors or tags 321, 322, and 323, 324 may be adhered to, embedded within, or otherwise attached to a portion of the respective construction item 311, 312, and 313.

The system 300 also includes a mobile or handheld device 330 for communicating with and/or obtaining information from the sensors or tags 321, 322, 323, and 324. Additional mobile or handheld devices 330 may be provided in additional embodiments.

The handheld device 330 communicates with a computer-based data processing system (“database/server”) 342 via access point 340. The database/server 342 includes one or more processors necessary for executing instructions for performing the location verification method provided herein.

Similar to the database/server 142 shown in and described with reference to FIG. 1, the database/server 342 includes, in a storage module, model data 344 for one or more construction sites. The model data 344 is downloaded to the database/server 342 and is, according to an embodiment, the modeled (x, y, z) location information for each of the construction items of interest (e.g., all of the construction items for the site 300 or a subset thereof).

According to various embodiments, the sensors or tags 321, 322, 323, and 324 may be barcode tags, RFID tags, GPS receivers, satellite receivers, or other tracking/sensing/locating sensors, tags, or devices that can be used to track/sense/identify a location of the corresponding construction item 311, 312, or 313.

The handheld device 330, according to the various embodiments, is compatible with the type of sensor or tag being used in the system 300. As such, the handheld device 330 may be, according to an embodiment, an RFID reader configured to read an RFID tag of the construction items 311, 312, and 313. In another embodiment, the handheld device 330 may be a GPS reader, configured to obtain a GPS signal from a GPS receiver of the construction items 311, 312, and 313.

The system 300 is not limited to any particular type of sensor/tag-reader. Instead, any location or sensing technology and its corresponding hardware (tags, receivers, readers, and the like) may be employed. In other embodiments, various or combinations of location technologies may be utilized by incorporating the necessary hardware components (e.g., transceivers, hand-held devices, or those necessitated by the particular technology or technologies being utilized).

According to an embodiment, in operation for the location verification method, the handheld device 330 is moved to a known location, S1 (331). S1 (331) has been previously surveyed using known methods, or one which the location has been identified through another embodiment described herein. Handheld device 330 is activated and communicates with items 311, 312, and 313 to receive timing information from tag 321, 322, 323 and 324, and transmits the timing information to the wireless AP 340. The timing information, via 340, is provided to the database/server 342, which converts the timing information to distance.

Handheld device 330 is then moved to a known location, S2 (332). S2 (332) has been previously surveyed similarly to S1 (331). Handheld device 330 is activated and once again communicates with items 311, 312, and 313 to receive timing information from the tags 321, 322, 323 and 324, and transmits the timing information to the wireless AP 340. The timing information, via AP 340, is provided to the database/server 342, which once again converts the timing information to distance.

Handheld device 330 is then moved to a known location, S3 (333), and the process is repeated. In alternative embodiments, additional locations S4, S5, . . . Sn can be utilized. Once the minimum required locations (S1, S2, . . . , Sn) have been completed, the database/server 342 uses triangulation and/or trilateration technology in conjunction with the already known locations of S1, S2, . . . , Sn, to locate the particular construction item 311, 312, and/or 313 corresponding to the RFID tags 321, 322, 323, 324 (e.g., determine the (x, y, z) location of the particular construction item). This is particularly advantageous when transceiver locations may be limited and/or reduced in quantity.

Once information or data indicative of the location of a construction item 311, 312, or 313 is obtained, the database/server 342 then compares the identified location to the extracted model data 344 for the particular construction item 311, 312, or 313 to determine if the location is correct or incorrect. A confirmation or alarm is generated, by the database/server 342, and sent to one or more user devices 350, as described above with respect to FIG. 1.

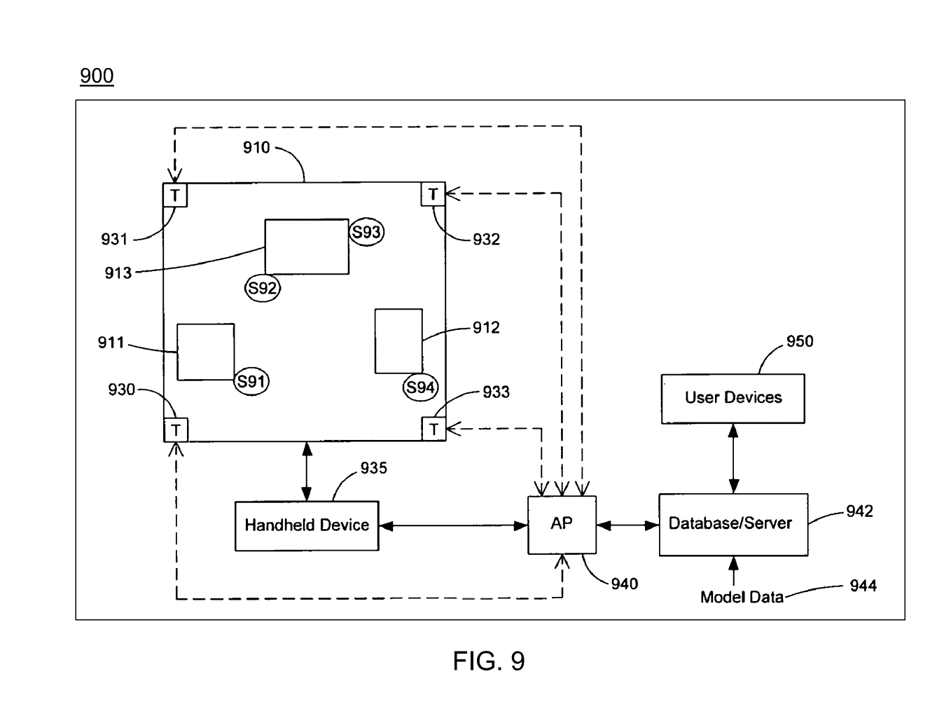

In an alternative embodiment, with reference to FIG. 9, a system 900 is provided for verifying location of a construction item at a construction site 910. In this embodiment, the construction site 910 includes various construction items 911, 912, and 913. These items are not required to have a tag, according to an embodiment. The system 900 also includes one or more transceivers (as shown, transceivers 930, 931, 932, and 933). Fewer or additional transceivers may be provided.

Also included in the system 900 is a wireless access point (AP) 940 and a computer-based data processing system (“database/server”) 942. The wireless AP 940 serves as a link between the transceivers 930, 931, 932, and 933 and the database/server 942. The wireless AP can be either a single unit or a system of units and/or other technologies known to those skilled in the art (i.e.,: Leaky coax, directional transceivers, etc.) capable of linking the database/server 942 to the transceivers 930, 931, 932, and 933. The database/server 942 includes one or more processors necessary for executing instructions for performing the location verification method provided herein.

The database/server 942 includes, in a storage module, model information for one or more construction sites. According to an embodiment, information (i.e., data) from the model (model data 944) for a construction site is downloaded or otherwise inputted to the database/server 942, to be used for the location verification method. The model of a construction site for a project may be, in an embodiment, a three-dimensional coordinated model that includes an architectural design model that is overlaid with drawings from various disciplines and contractors (e.g., electrical and plumbing). The model identifies a location (x, y, z) for the construction items to be used in the construction project. The model data 944 that is downloaded to the database/server 942 is, according to an embodiment, the modeled (x, y, z) location information for each of the construction items of interest (e.g., all of the construction items for a site or a subset thereof).

The transceivers 930, 931, 932, and 933 are configured to receive timing information from one or more handheld devices 935 and transmit the timing information to the wireless AP 940. The timing information via AP 940 is provided to the database/server 942, which converts the timing information to distance and uses trilateration technology to locate handheld device 935 (e.g., determine the (x, y, z) location of handheld device 935).

Handheld device 935 is then placed momentarily at a reference point S91 and signals to the database/server 942 that it is located at construction item 911 via transceivers 930, 931, 932, and 933. The identification of the construction item 911 can be performed through various embodiments, such as via the handheld device 935 reading information locally from the construction item (e.g., via a barcode on the item, an RFID tag on the item, etc.), via the handheld device 935 scanning a coded symbol on an associated set of model drawings, via acceptance of a choice on the handheld device 935, via manual inputting of the item, etc.

The database/server 942 then compares the identified location to the extracted model data 944 for the particular construction item 911, to determine if the location is correct or incorrect. A confirmation or alarm is generated, by the database/server 942, and sent to one or more user devices 950.

This procedure may be repeated for each construction item 912, 913 (etc.) to locate/validate each construction item.

In an alternative embodiment, the actions are similar except that the AP 940 communicates with the handheld device 935, which collects and transmits the timing information to the database/server 942 via the AP 940.

In another embodiment, the handheld device 935 location is not associated with any extracted model data, but the location can be used for location and/or verification of items in an ad-hoc fashion.

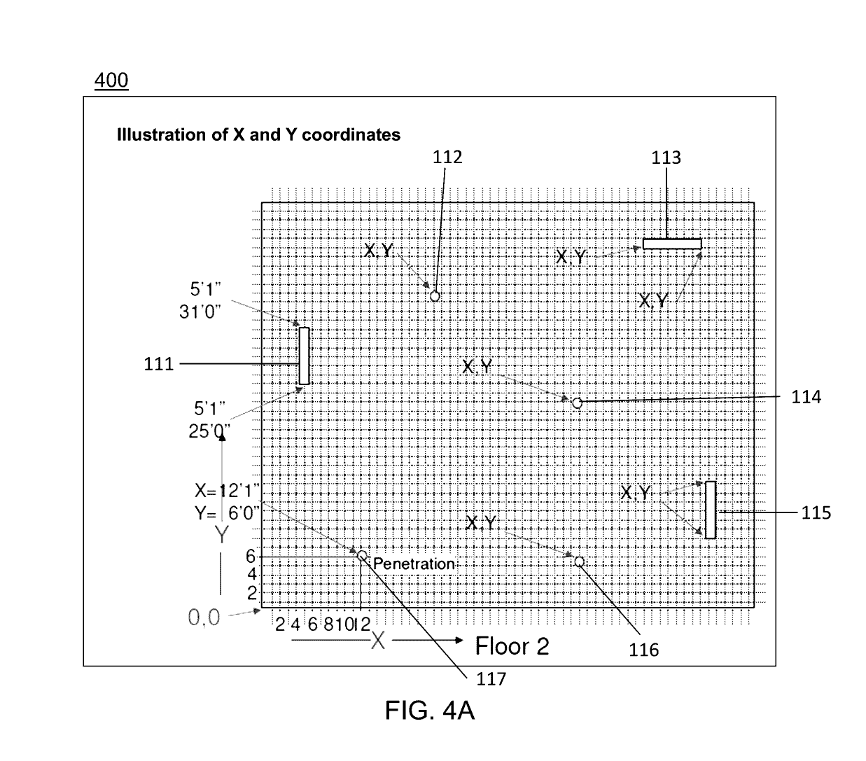

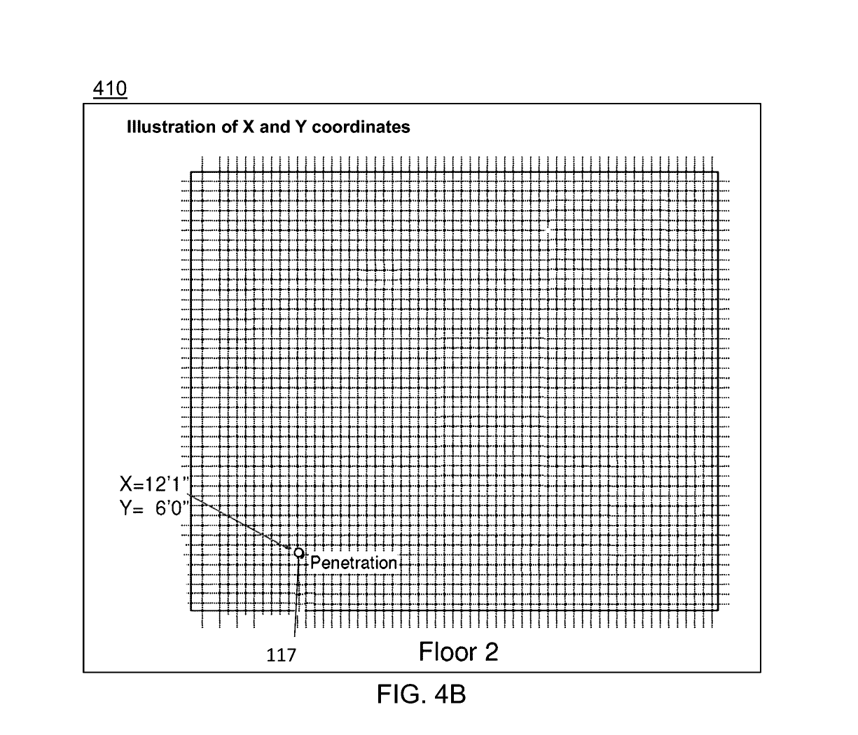

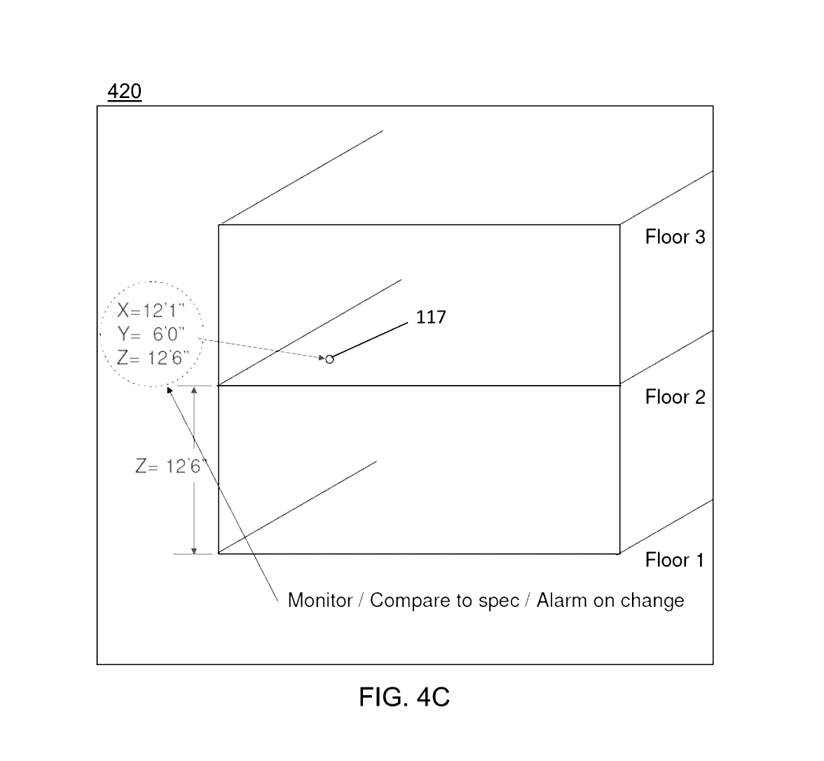

FIGS. 4A-4C are example site diagrams 400-420 illustrating model data and location information for construction items at a construction site, according to an embodiment. As shown, various construction items 111, 112, 113, 114, 115, 116, and 117 are assigned a location (x, y, z) on a site. In some embodiments, a construction item has two or more sets of data associated with it; for example, a first set of (x, y, z) coordinates indicating one edge of the construction item and a second set of coordinates indicating a second edge of the item. Such information may be used for the orientation of an item.

With respect to orientation of a construction item, depending upon the particular construction item, orientation may be important or vital in the placement of the item. Thus, in addition to the (x, y, z) location data, the model data for one or more construction items may also include data on correct orientation, which may include more than one set of (x, y, z) coordinates for a particular construction item. When the identified data for a particular construction item is obtained and provided to the database/server, the database/server may also compare the orientation data (e.g., the multiple sets of coordinates) to that dictated by the model to determine if the orientation of an item to be placed at a site is correct.

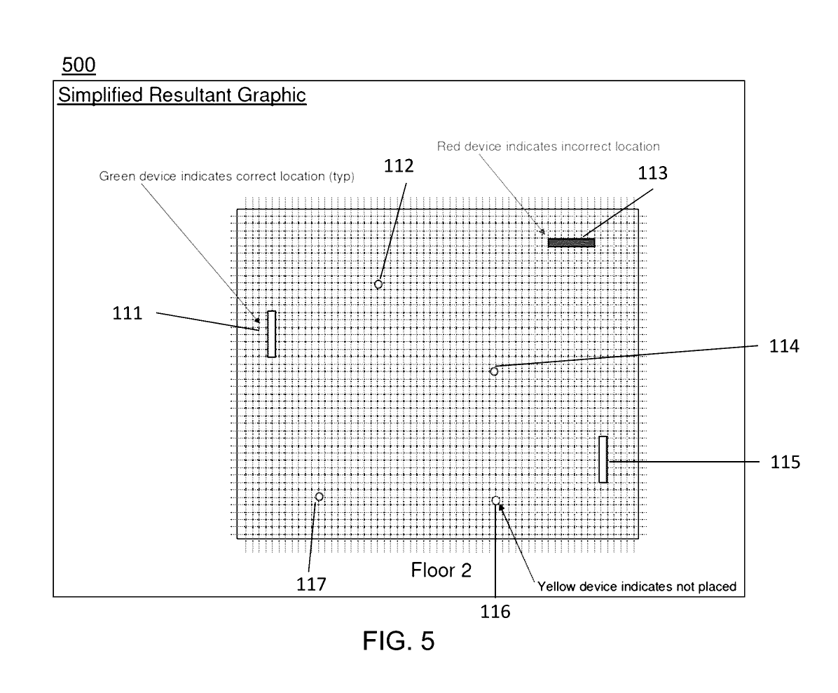

FIG. 5 is an example resultant graphic 500 generated upon implementation of a location verification method provided herein, according to an embodiment. In this embodiment, a site diagram with one or more construction items 111, 112, 113, 114, 115, 116, and 117 may be color-coded to indicate if the identified location of the items is correct (e.g., green) or incorrect (e.g., red). If the item has not yet been placed, the graphic may also indicate this status (e.g., yellow). Other than or in addition to color, other coding attributes (e.g., shading, markings, text descriptions, etc.) may be used on the resultant graphic to indicate to a user a status of placement of one or more construction items 111, 112, 113, 114, 115, 116, and 117.

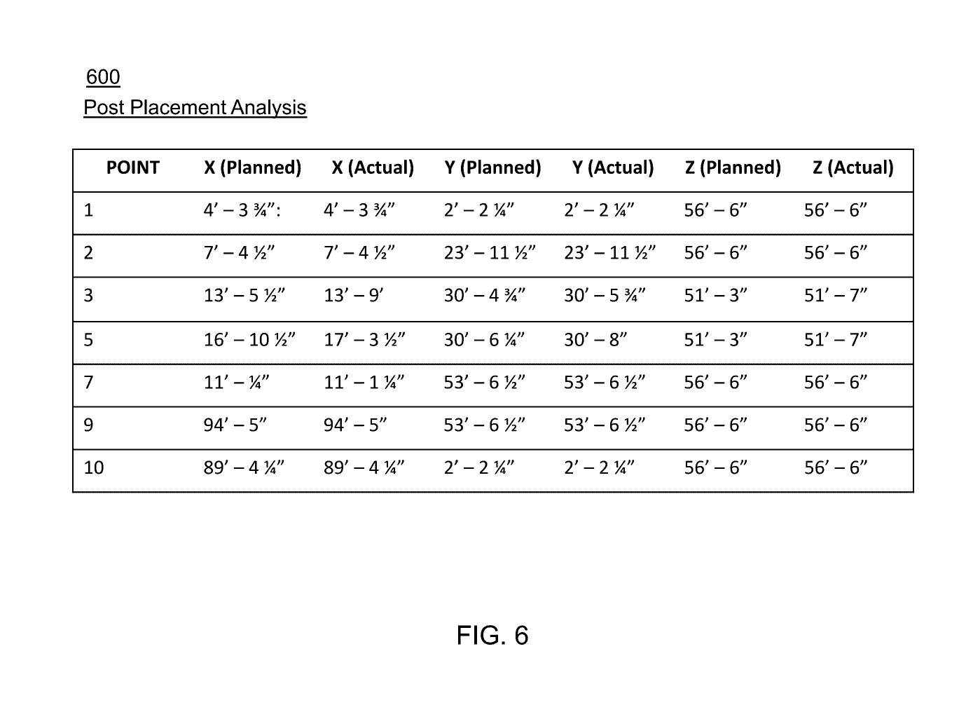

FIG. 6 is an example conformance report 600 generated upon implementation of a location verification method provided herein, according to an embodiment. The conformance report includes the model data and the received data indicative of the actual location of the construction item or items. Items in an incorrect location may be highlighted, marked, color-coded, or otherwise flagged to bring the error to the user's attention.

The exemplary resultant graphics and conformance reports described above with respect to FIGS. 5 and 6 may be generated at predetermined time intervals, allowing a user, such as a product manager, the ability to review items being placed in the given time interval. Alternatively or additionally, the exemplary resultant graphics and conformance reports may be generated after placement of a predetermined number of construction items, or after placement of one or more specified items that may be identified by a user. The alarm messages described above may also be generated in addition to the exemplary resultant graphics and conformance reports, to serve as an additional warning to a user, allowing the user to promptly take corrective action before the construction item is finalized or secured in place. In an embodiment, the exemplary resultant graphics and conformance reports may be generated continuously in real time.

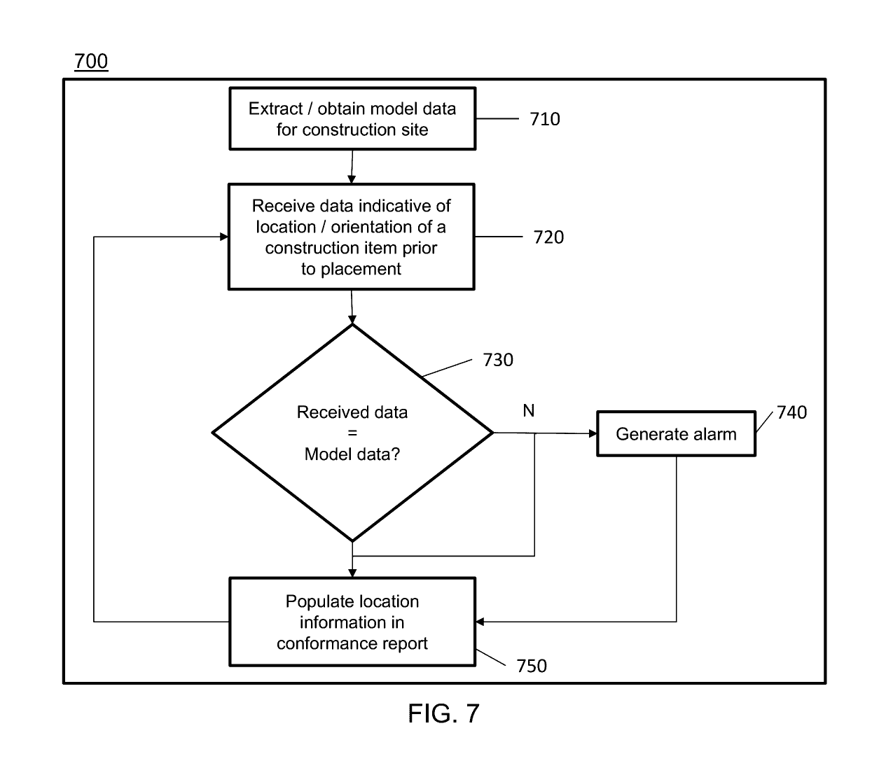

FIG. 7 is a flowchart 700 illustrating an exemplary method for verifying location of a construction item at a construction site, according to an embodiment.

At 710, model data for a construction site is extracted from the model of the construction site. The model data includes a location (x, y, z) for the construction items to be used in the construction project, and may also include data on orientation for one or more construction items. In an embodiment, the model data is downloaded to a database/server for use in a location verification method provided herein. According to an embodiment, portions of the model (i.e., model data pertaining to particular construction items) may be downloaded at different stages of construction of the site, the entire model may be downloaded at one time, or portions of the model may be updated or downloaded as determined by one or more users.

At 720, data indicative of location/orientation of a construction item is received prior to permanent placement or finalization of the construction item. As described above, various technologies may be implemented in determining or identifying a location of construction items, as will be appreciated by one of ordinary skill in the art. Depending upon the technology being utilized, the server that receives the data may need to process the data to determine the location of the construction item (e.g., convert timing data to distance data).

At 730, the server determines if the received data indicating the location of the construction item matches, or is equivalent to, the model data. A tolerance can be applied to each construction item, allowing the location to still be considered correct (i.e., equivalent) when an error below the tolerance is sensed. An example, in one embodiment, of an acceptable tolerance is ¼ inch. In additional embodiments, an acceptable tolerance is based upon the type of the construction item. The location and/or orientation of the construction items may need to be in accordance with, at minimum, the code applicable to that type of item; therefore, the accuracy and the precision of the location verification methods and systems provided herein needs to be equal to or less than the allowable tolerance. The Steel Codes, Concrete Codes, and Building Codes (for example, American Concrete Institute (ACI), American Institute of Steel Construction (AISC), New York City Construction Code, and other federal, state, or industry-standard codes) govern the allowable tolerance for the placement of a construction item. These tolerances can be made more stringent by the architects and/or engineers through their specifications for a certain project based on the project demands. Different construction items may have varying tolerances based on the codes that are applicable to the construction items. While these tolerances can have varying ranges, they generally fall in the range between ⅛″ and 3″.

As one example: In placing steel columns, the standard that is set forth by the AISC states that a column needs to be plumb within 1″ over 500 Feet of Rise. Therefore, if the building is 500 feet tall the position of the column would be allowed to vary by a total of 1″ from the original, designed position. For one reason or another, the engineer may determine that for steel columns on a particular building can only be ½″ tolerance over 500 feet of rise. Being that the engineer introduced a tighter tolerance, this tolerance value would govern and need to be followed. Thus, in this example, the location verification systems and methods would need to be accurate to ½″ in all the 3 dimensions (x, y, z).

An additional example is with respect to the manual fire pull station. According to code NFPA 72, a mounting height of a manual fire pull station must be between 3½ and 4½ feet from floor to handle. As such a vertical tolerance of +/−6″ is acceptable.

Additionally, location tolerances may also include rules that are based upon the design model with an added set of criteria. For example, the location of a smoke detector in the design model may be variable and allowed to be field coordinated with ceiling lighting. However, the NFPA 72 code requires that once installed, smoke detectors must be no more than 21 feet apart. In this example, the tolerance would be within 21 feet of the nearest smoke detector. Any detectors located greater than this distance would be considered non-conformant.

In another embodiment, one or more of the construction items for a particular construction site may be defined as “critical” items with a stricter tolerance than other items identified is “non-critical.” In one embodiment, critical items refer to those items that are relied on for placement of subsequently installed items. For example, a pipe that is connected to other pieces of piping may be defined as critical, and hence the placement needs to be within a defined tolerance. On the other hand, placement of an electrical outlet or light switch, for example, may not affect placement of other items and may hence be defined as non-critical with a less strict tolerance.

Returning to FIG. 7, at 740, following a determination that the received data and the model data do not match, an alarm is generated to warn a user of the error in location of the construction item.

At 750, following a positive determination that the received data and the model data match or a negative determination that they do not match, the location information is populated in a conformance report.

The process may continue for various other of the construction items for the construction site, thus providing for an alarm upon a negative location determination and completion of a conformance report, that may be generated at various time intervals and/or upon a predefined number of placements of construction items, and/or in real time.

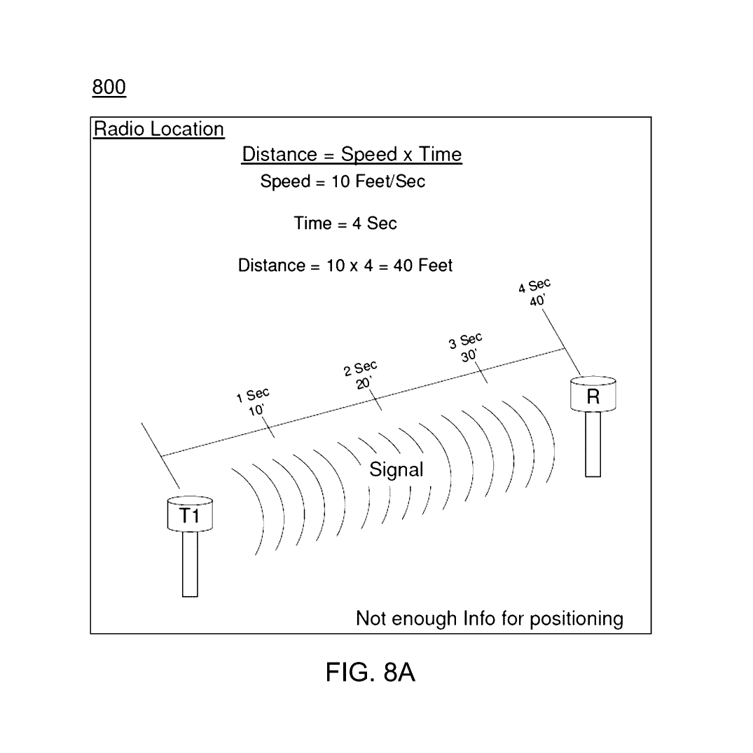

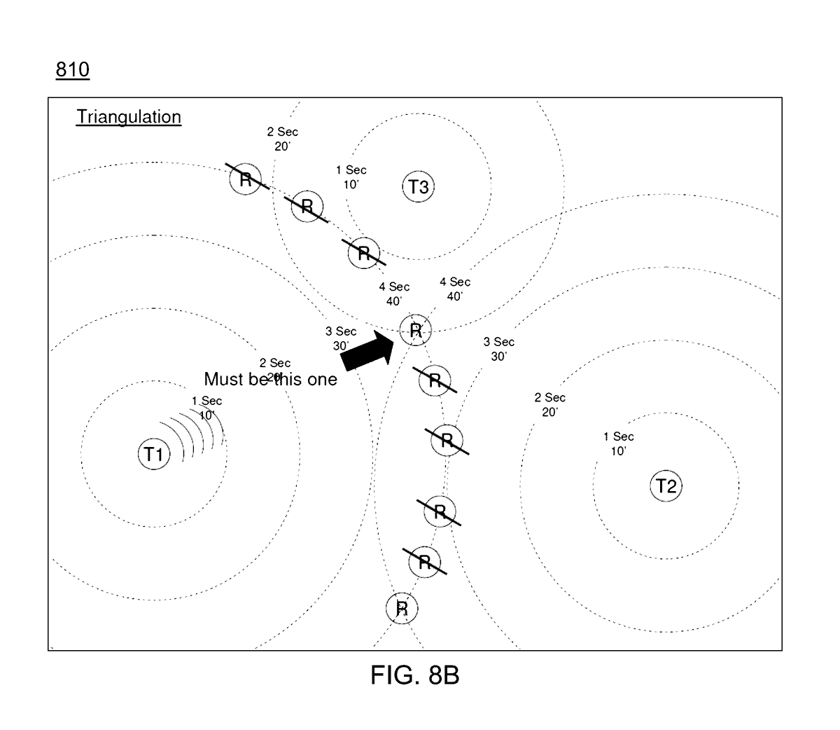

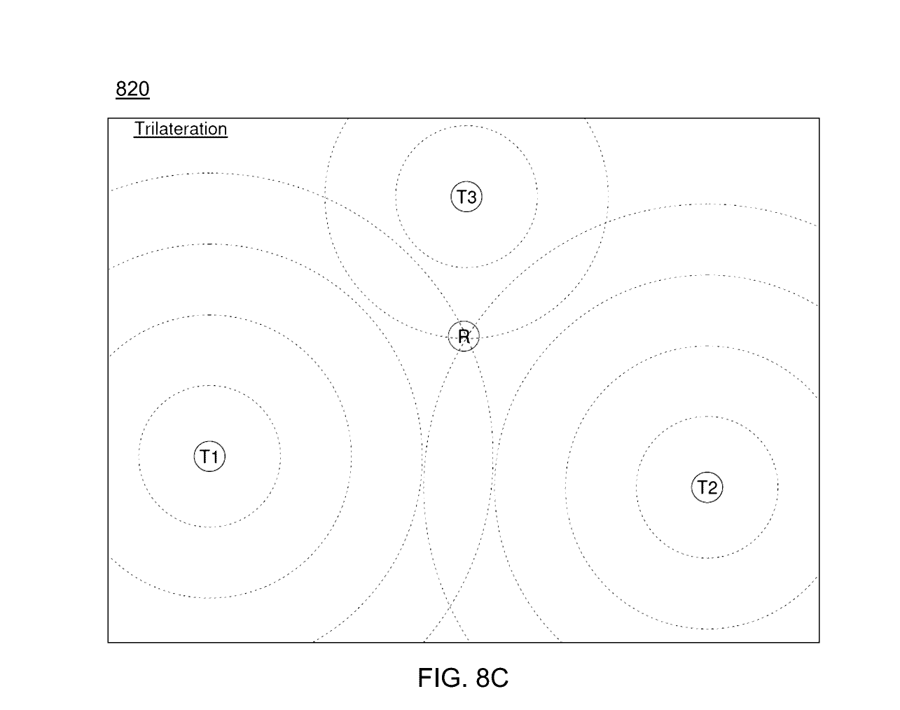

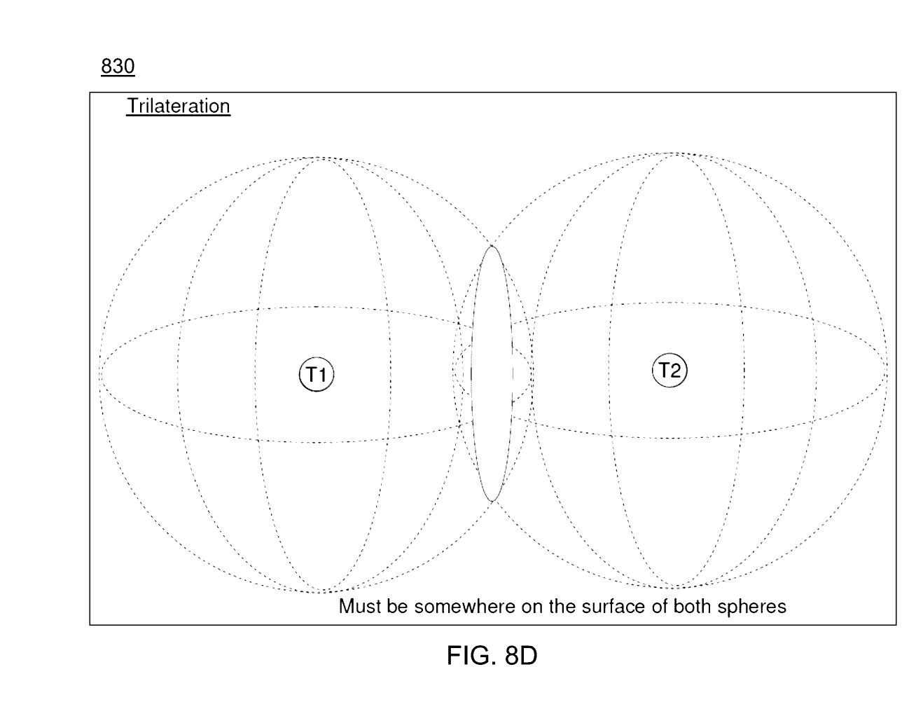

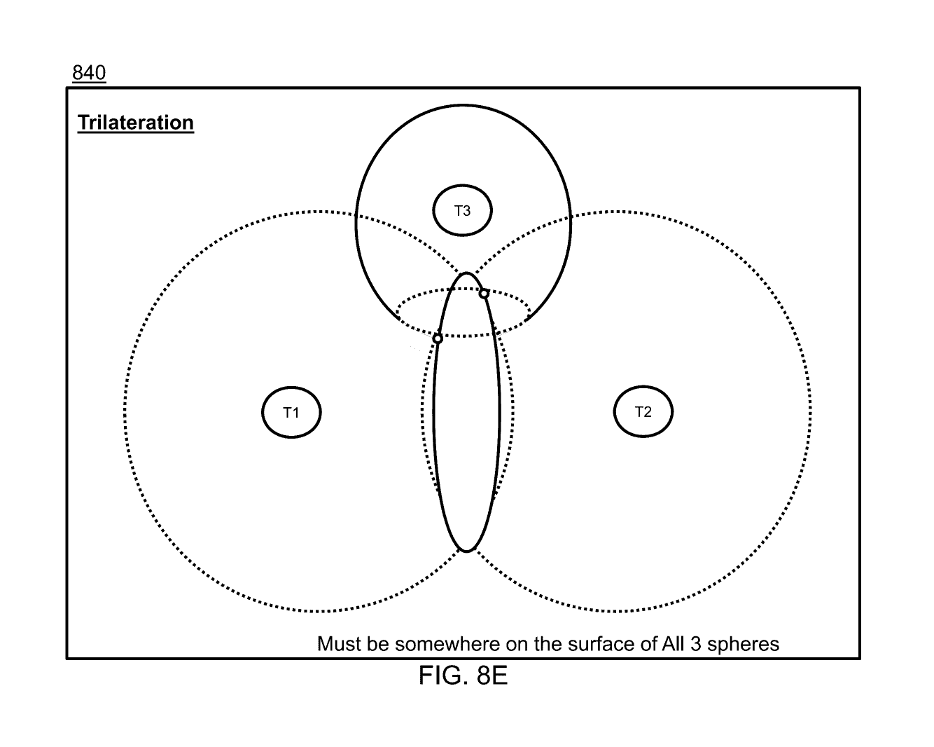

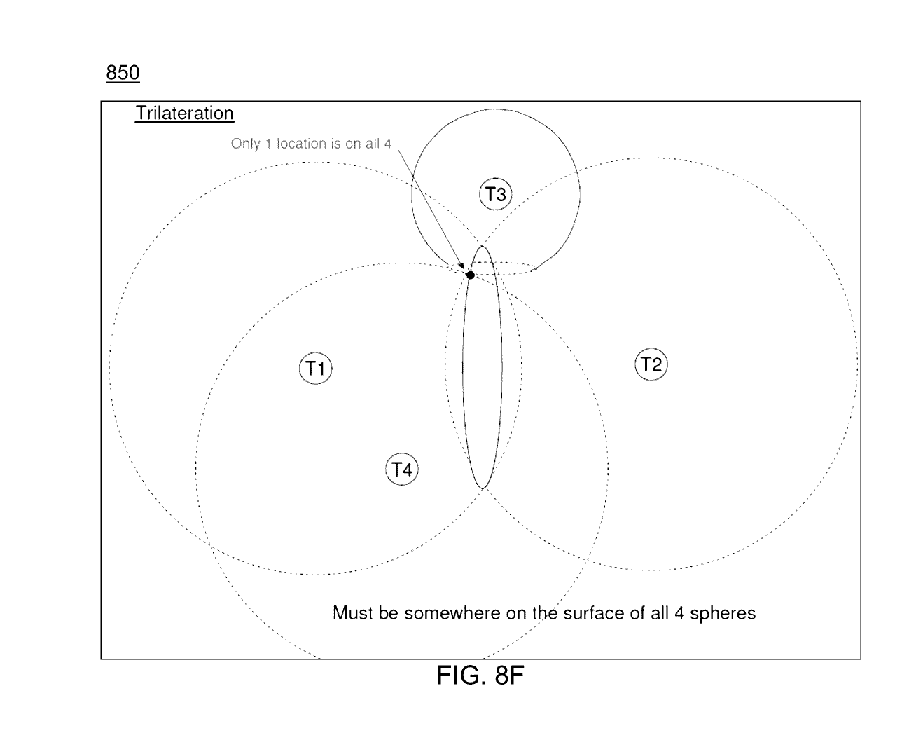

FIGS. 8A-8F are a series of diagrams 800-850 illustrating features of trilateration, one exemplary technology that may be utilized with aspects provided herein for verifying location of a construction item at a construction site. Again, as described above, the location verification systems and methods are not limited to one type of location technology. Rather, various forms may be utilized to identify locations of items.

In alternative embodiments, the transceivers will communicate between themselves and/or the wireless AP and/or the handheld device.

A significant advantage of the real-time, automated location verification systems and methods provided herein is that the technology can easily be integrated into everyday construction and can easily be adopted without major disruption to well-established/entrenched building practices, methods, and procedures. The technology does not change aspects of the way that structures are built other than providing an efficient, rapid, and real-time method to verify that the placement of the many building items are placed correctly prior to finalization and will not have to be removed and replaced, resulting in wasted time and money. As such, the real-time, automated location verification systems and methods act as the ultimate third party inspection, requiring no significant additional work yet providing significant benefits. Also, the real-time, automated location verification systems and methods are not limited to specific projects but have value to any construction project.

As described above, the concept of prior to permanent placement or finalization is critical for the real-time, automated location verification systems and methods provided herein. After the construction items are secured (i.e., permanently secured or finalized in a location), measures for correcting an error are costly and time-consuming. A significant advantage of the systems and methods provided herein is that an alarm is generated once an item is positioned, but prior to permanent placement or finalization.

Another factor contributing to the advantages of the real-time, automated location verification systems and methods provided herein is the large volume of construction items typically used in a construction site. With the systems and methods provided herein, alarms and reports are generated with the location information of construction items in real-time, eliminating the need for one or more people to visually inspect each item, which is time-consuming and error-prone. Moreover, at certain times, it is infeasible for a person to inspect each and every item. Thus, the real-time, automated location verification systems and methods disclosed herein provide a benefit in warning a user of a potential error before it occurs (i.e., before finalization of a construction item).

It will be appreciated that the above figures and description provide exemplary, non-limiting configurations. Although the present invention has been described with reference to these exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

We claim:

1. A system for real-time, automated location verification to ensure that construction items are installed in a correct position and orientation in three dimensions as identified by model data for a construction site, the system comprising:
one or more construction items, each with a corresponding tag, on the construction site;
a database for storing the model data for the construction site;
one or more transceivers located on the construction site;
a server in communication with the database and the one or more transceivers, the server configured to:
receive, from one or more of the one or more transceivers, data indicative of one or more of a location and an orientation of one of the one or more constructions items at the construction site;
determine if the model data and the received data relating to the one of the one or more construction items at the construction site are equivalent; and
store data indicative of the determination.

2. The system of claim 1, wherein the server is further configured to:
provide, to one or more user devices in communication with the server, a communication reflective of the determination prior to finalization of the one of the one or more construction items.

3. The system of claim 2, wherein the communication reflective of the determination comprises one or more of (i) an alarm message sent to one or more of the one or more user devices; (ii) a conformance report indicating the one of the one or more construction items, the model data, and the received data; and (iii) a graphical format describing one or more of: a correctness of the location of the one of the one or more construction items; a correctness of the orientation of the one of the one or more construction items; and an absence of the one of the one or more construction items.

4. The system of claim 2, wherein the server provides the communication reflective of the determination at one or more of (i) upon the determination by the server and (ii) a predetermined time interval.

5. The system of claim 1, wherein the corresponding tags of the one or more construction items communicate to one or more of the server and each other over one or more of a network and a mesh network.

6. The system of claim 5, wherein the corresponding tags comprise one of a barcode tag, a radio frequency identification (RFID) tag, a global positioning system (GPS) tag, and an ultra-wide band tag.

7. The system of claim 6, wherein the corresponding tags of the one or more construction items communicate with the one or more transceivers configured to receive timing information from the corresponding tags of the one or more construction items and transmit the timing information to the server over a wireless access point.

8. The system of claim 7, wherein the server is further configured to convert the timing information to distance information to locate the one of the one or more construction items.

9. The system of claim 1, further comprising:
one or more hand-held devices configured to (i) read data from the tag of the one of the one or more construction items, and (ii) transmit the read data to the server.

10. The system of claim 1, wherein the model data and the received data for the one of the one or more construction items comprises one or more sets of (x, y, z) coordinates.

11. The system of claim 1, wherein the server is further configured to extract the model data for the construction site from a three-dimensional coordinated model of the construction site.

12. The system of claim 1, wherein the server is further configured to, in the determination of if the model data and the received data relating to the one of the one or more construction items at the construction site are equivalent, apply one or more tolerances to the one of the one or more construction items, the one or more tolerances based on at least one of federal, state, local, and industry standard codes.

13. A method for real-time, automated location verification to ensure that construction items are installed in a correct position and orientation in three dimensions as identified by model data for a construction site, the method comprising:
storing, at a database associated with a server, the model data for the construction site;
receiving, at the server, from one or more transceivers located on the construction site, data indicative of one or more of a location and an orientation of one of one or more constructions items at the construction site;
determining, by the server, if the model data and the received data relating to the one of the one or more construction items at the construction site are equivalent; and
storing, by the server, data indicative of the determination.

14. The method of claim 13, further comprising:
providing, to one or more user devices in communication with the server, a communication reflective of the determination prior to finalization of the one of the one or more construction items.

15. The method of claim 14, wherein the communication reflective of the determination comprises one or more of (i) an alarm message sent to one or more of the one or more user devices; (ii) a conformance report indicating the one of the one or more construction items, the model data, and the received data; and (iii) a graphical format describing one or more of: a correctness of the location of the one of the one or more construction items; a correctness of the orientation of the one of the one or more construction items; and an absence of the one of the one or more construction items.

16. The method of claim 13, wherein the model data and the received data for the item comprises one or more sets of (x, y, z) coordinates.

17. The method of claim 13, further comprising:
extracting, at the server, the model data for the construction site from a three-dimensional coordinated model of the construction site.

18. A system for real-time, automated location verification to ensure that construction items are installed in a correct position and orientation in three dimensions as identified by model data for a construction site, the system comprising:
one or more construction items, each with a corresponding tag;
a database for storing the model data for the construction site;
one or more movable transceivers positioned sequentially at one or more surveyed locations on the construction site, the one or more movable transceivers configured to receive timing information from the corresponding tags of the one or more construction items; and
a server in communication with the database and the one or more movable transceivers, the server configured to:
receive, over a wireless access point from one or more of the one or more movable transceivers, the timing information for one of the one or more construction items;
convert the timing information to distance information to locate the one of the one or more construction items;
determine if the model data and the converted distance information relating to the one of the one or more construction items at the construction site are equivalent; and
store data indicative of the determination.

19. A system for real-time, automated location verification to ensure that construction items are installed in a correct position and orientation in three dimensions as identified by model data for a construction site, the system comprising:
one or more construction items;
a database for storing the model data for the construction site;
one or more fixed transceivers positioned on the construction site;
one or more movable transceivers positioned sequentially at one or more of the one or more construction items on the construction site, the one or more movable transceivers configured to receive timing information from the fixed transceivers; and
a server in communication with the database and the one or more movable transceivers, the server configured to:
receive, over a wireless access point from one or more of the one or more movable transceivers, the timing information for one of the one or more construction items;
convert the timing information to distance information to locate the one of the one or more construction items;
determine if the model data and the converted distance information relating to the one of the one or more construction items at the construction site are equivalent; and
store data indicative of the determination.

20. The system of claim 19, wherein the one or more movable transceivers read data from coding on a model drawing representing the one of the one or more construction items, and transmit the read data with the timing information to the server to coordinate a desired location with the model data at the server.

21. The system of claim 19, wherein the one or more movable transceivers read data from a tag of the one of the one or more construction items, and transmit the read data with the timing information to the server to coordinate a desired location with the model data at the server.

22. The system of claim 19, wherein the one or more movable transceivers obtain input from a user as to an ad hoc location of the one of the one or more construction items, and transmit the input with the timing information to the server to coordinate a desired location with the model data at the server.
